(19) United States
(12) Patent Application Publication
(10) Pub. No.: US 2003/0028651 A1
(43) Pub. Date: Feb. 6, 2003

(54) Proprietary information utility

(76) Inventors: James O. Schreckengast, Fort Collins, CO (US); Anton I. Engberg, Auburn, CA (US)

Correspondence Address: HEWLETT-PACKARD COMPANY, Intellectual Property Administration, P.O. Box 272400, Fort Collins, CO, 80527-2400, US

(21) Appl. No.: 09/919,153

(22) Filed: Jul. 31, 2001

(51) Int. Cl. G06F 15/16

(52) U.S. Cl. 709/229; 705/52

(57) ABSTRACT

A proprietary information utility includes an interface that provides outside entities connection to the proprietary information utility. A repository contains proprietary information. The repository is compartmentalized by user identity and entitlement. A security system limits access of each user connecting to the proprietary information utility to proprietary information to which each user is entitled. The proprietary information to which each user is entitled is through use of the application services operating within the proprietary information utility. A billing system tracks usage of users of the proprietary information utility for billing purposes.

### BACKGROUND

The present invention pertains to communication over computer networks and pertains particularly to a proprietary information utility.

Software applications are often sold as products that include the application software and any supporting libraries, templates, sample data, models, or other associated proprietary information that may be required for the normal operation of the software application. What is meant by proprietary information is any data, information, know-how, and so on that could be regarded as intellectual property. Software vendors often protect this proprietary information through the terms of their license. In some cases a vendor obfuscates the proprietary information or employs other means of protection, such as encryption.

Most powerful software applications have disadvantages for the user and the software vendor. For example, the software applications must often ship with a great deal of data, which is stored in the user's computing environment. Also, the software applications often demand significant memory, central processing power, and storage to operate effectively. The user must supply these resources. This makes deployment of powerful software applications in some portable computing environments difficult or impossible. Also, software applications and the associated proprietary information must be refreshed periodically by the vendor so that the user can take advantage of new features or use updated proprietary information. The vendor will often charge a subscription or product update fee for this service. Additionally, any customizations the user may have made to the software or environment must often be migrated to new versions of the software. This can be expensive. Also, software applications are often quite expensive, because the vendor cannot easily determine how often, or to what extent the purchaser will use the software. Thus, the software vendor prices the software at a level that assumes a high level of utility for the software application. This often' prevents casual users or fragmented users from accessing the software application.

The advent of client-server computing addressed some of the shortcomings associated with traditional software products. In client-server environments, software vendors create a lightweight version or component of the software product for desktop and portable computers while providing a heavier server portion of the product that included much of the associated proprietary information. Users can purchase one server with significant computing resources and spread the costs of these resources among multiple users. The maintenance problems associated with multiple users is reduced, and customization is easier to accommodate and maintain.

Client-server computing also has drawbacks. For example, there can be version mismatches between client and server software. Coordinated updates are often required, but portable clients can be difficult to track and administer. Additional processes need to be developed to support this environment. Also, the uncertainty associated with the quality of newly released software, along with the fact that multiple users are impacted by an update has caused information technology (IT) departments to become somewhat risk averse in implementing new releases. This has caused early-adopters to become dissatisfied with the timeliness of updates, while laggards often complain of disruptions due to defects in new software. Also, server software is expensive, slowing the adoption of unproven, new technologies. Additionally, the need for updates and refreshed data persists, making the administration of these environments expensive.

Application service providers (ASPs) are now providing access to application software on the Internet, without the need for the user to provide expensive hardware or other resources to manage the application software. This allows vendors to host and administer their application software and update or refresh the associated proprietary information in real-time. Further, since the vendor can directly measure who is using the application software and to what extent the application software is being used, the vendor is able to develop pricing models that match product utilization. This greatly reduces the risk to a user of trying a new or unproven technology and increases the utility of such software for small or growing businesses.

There are problems that have arisen with application service provider models. For example, application software delivered in this model have evolved from traditional software products and tend to be vertically integrated, making it difficult to share data among multiple application programs, unless the application programs are all part of an application service provider suite. This places many customers in an all-or-nothing situation when selecting ASP-delivered application software. Also, control of customer data and privacy is a concern among many customers. Most are reluctant to store company confidential data within an ASP hosted environment. However such storage of confidential data within an ASP hosted environment is often required to ensure that a customer can use the application software and access associated data from any location. Additionally, customizations are still performed in an ASP environment to address some deficiency or special requirements for a customer. ASP environments are typically quite generic, since the same environment must address the needs of all customers. Customers typically have no way to share customizations or enhancements, and most ASPs provide no incentive to do so.

### SUMMARY OF THE INVENTION

In accordance with the preferred embodiment of the present invention, a proprietary information utility includes an interface that provides outside entities connection to the proprietary information utility. A repository contains proprietary information. The repository is compartmentalized by user identity and entitlement. A security system limits access of each user connecting to the proprietary information utility to proprietary information to which each user is entitled. The proprietary information to which each user is entitled is accessed through use of the application services operating within the proprietary information utility. A billing system tracks usage of users of the proprietary information utility for billing purposes.

### BRIEF DESCRIPTION OF THE DRAWINGS

FIG. 1 is an example of interaction with a proprietary information utility in accordance with a preferred embodiment of the present invention.

FIG. 2 is a simplified block diagram of a proprietary information utility in accordance with a preferred embodiment of the present invention.

FIG. 3 is an example of revenue flow over a network in accordance with a preferred embodiment of the present invention.

### DESCRIPTION OF THE PREFERRED EMBODIMENT

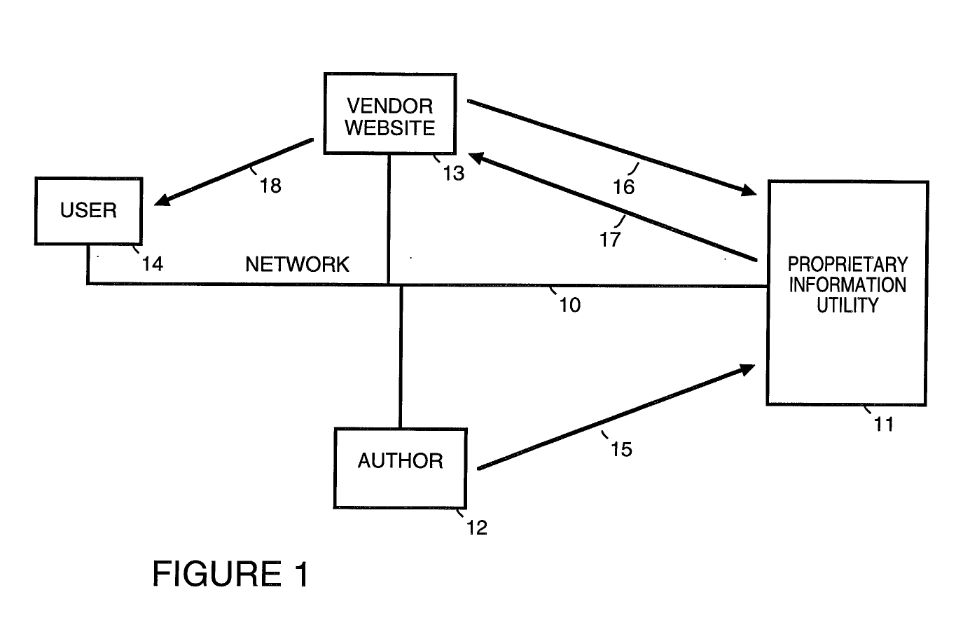

FIG. 1 is an example of interaction with a proprietary information utility 11. Proprietary information utility 11 is at the center of commerce. Proprietary information utility 11 facilitates transactions for authoring, publishing, manipulating, analyzing, and buying/selling access to proprietary information through a set of application services. An operator of the proprietary information utility 11 make take a percentage of all revenue that flows through the system, and is the recipient of revenue for operator-provided application services that enhance proprietary information utility 11 or present views into the proprietary information or manipulate proprietary information, based upon the unique visibility available to the operator. In addition to or instead of the operator taking a portion of all revenue that flows through the system, the operator can take, for example, fixed compensation to cover a particular volume. The form of compensation is tailored to the needs of each industry that uses proprietary information utility 11.

A network 10 represents any type of network or link on which information is transferred. The network may include, for example, hard wired connections, wireless connections, optical connections, transportation services and/or any other type of media or service by which information may be transferred.

A vendor is represented in FIG. 1 by a vendor website 13. The vendor is anyone who sells (represented in FIG. 1 by an arrow 18) services or products that incorporate the proprietary information-based services of the proprietary information utility 11 or relies upon these services (as represented in FIG. 1 by an arrow 17) to enhance the performance of their product or service. The vendor may also author proprietary information or provide additional services through proprietary information utility 11 (represented in FIG. 1 by arrow 16), but this is not required. The vendor typically sells its products or services and chooses to either directly pass along the costs associated with proprietary information utility 11 or absorbs this costs through its own business model. A subset of vendors will provide core utility services, which run in the scaling computing engine. These vendors will receive revenue associated with the usage of these services. Utility services are application services or any other type of service provided from within proprietary information utility 11.

An author of proprietary information is represented in FIG. 1 by an author 12. An author provides or contributes to proprietary information contained within proprietary information utility 11. Proprietary information utility 11 translates information from an author into a utility-native proprietary information format which is stored in proprietary information library 27. In this format the translated information can be used by other utility services. An incentive is provided for authors to contribute proprietary information to proprietary information utility 11, for example, by providing the opportunity for author 12 to earn royalty payments when their proprietary information is made available through other services.

Alternatively, authors can choose to keep the proprietary information completely private and use services only for their own benefit. Typically, authors will have net expenses in proprietary information utility 11 when they use storage and other resources and do not the services to others. Authors can expect the greatest return by making their information “public.” By public, is meant that all users are entitled to use the information through services and all other authors are permitted to build upon the existing information

Authors may not pay to build on the works of some other authors. Instead, the other authors are ultimately compensated through the increased use of their work, both in its original form and in its derived works. An author may pay for value-added utility services, which enhance the author's work, improve the author's productivity, or enhance the author's revenue.

Alternatively, authors may pay for access to proprietary information libraries. This is one way in which an author may restrict use of the author's work to particular groups. For example, a first author contributes detailed proprietary information on dental surgery, but chooses only to publish the information to a group he defines as the “Dental Authoring Library.” Other authors are entitled to use this library if they are a member of this group. Membership to this group is obtained by paying a subscription fee. This compensates the first author for developing highly specialized information for which a relatively captive audience may benefit. It also provides a way to shift the revenue burden between customers and value-added authors. If an author does not pay, the author is free to use public information, information which the author owns, information in groups which the author may inherit through other affiliations, and any information which is published to the author. So, it will often be the case that authors will pay for access to some libraries of information. The method of payment can be somewhat indirect.

Authors interact with proprietary information utility 11, as represented in FIG. 1 by an arrow 15. For authors, the interaction is typically with authoring services (e.g., editors or generators).

In FIG. 1, an end user of services provided by a vendor or provided directly by proprietary information utility 11 is represented by a user site 14. User site 14 can be, for example, a personal computer, a notebook computer a computer digital assistant, an enhanced page, an enhanced cellular phone or any device with processing power. The users often pay for a solution that incorporates services provided by proprietary information utility 11. The user may be completely unaware that the user is using proprietary information utility 11. This is often the case when the user is using a product or service sold by a vendor.

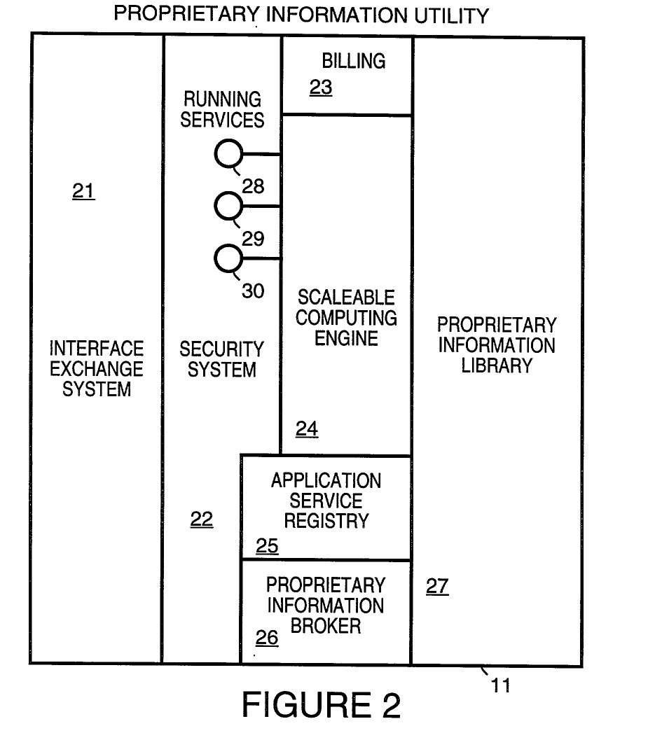

FIG. 2 is a simplified block diagram of proprietary information utility 11. A billing system 23 is responsible for tracking all transactions of proprietary information and creating the appropriate bills and accounting for reporting.

A compartmentalized proprietary information library 27 is a repository that contains the proprietary information generated by authoring application services. The repository is compartmentalized by identity of the user and entitlement records stored in a security system 22. For example, a particular user has access (through application services) to all proprietary information in the user's private domain, all proprietary information granted to the user through one or more group domains, all proprietary information granted to the user by license, and all public information available to proprietary information utility 11. Access to this information occurs solely through application services, running within proprietary information utility 11, that make use of the proprietary information.

A security system 22 is used to authenticate all users of proprietary information utility 11 and provide appropriate access to the application services and proprietary information, consistent with the user's entitlement and granted visibility. Further, security system 22 provides non-repudiation services in support of billing and reporting. Finally, security system 22 provides privacy for all information transmitted outside of proprietary information utility 11, allowing proprietary services to make use of proprietary information utility 11 without revealing anything about the users of the service or the contents of the data moving between services. Running application service 28, running application service 29, and running application service 30 are examples of proprietary application services running within the protection of security system 22.

A scaleable computing engine 24 provides processing power to proprietary information utility 11. For example, the architecture of proprietary information utility 11 enables millions of simultaneous users to simultaneously access and use computationally intensive services, operating on billions of proprietary information models in near real time to real time. In the preferred embodiment, proprietary information utility is also dynamic, allowing resources to be “switched in” as needed to handle dynamic loads.

A proprietary information broker 26 is a general facility that maps semi-structured proprietary information requests to the most appropriate proprietary information models and the application services that will operate on these models. For example, a user may describe a medical symptom and the appropriate diagnostic services will be invoked on the relevant medical knowledge models to attempt to diagnose and treat an underlying condition. These appropriate diagnostic services may involve radically different technologies. The user is typically shielded from the fact that different technologies are brought to bear, the specific problem to be solved, the available models, and the scoring mechanism that the broker uses to optimize this decision.

Proprietary information broker 26 may federate a number of services to provide a specific service to the user. This all happens transparently to the user within proprietary information broker 26. For example, suppose that a user wishes to use a “Silicon decisions” service to capture the expertise required to troubleshoot a cellular phone on a chip. Although proprietary information utility 11 may provide such a service on behalf of a particular vendor participating in proprietary information utility 11, the service may require knowledge in a particular format (i.e., a neural network) in order to produce the chip. Proprietary information broker 26 could find a path by federating services to produce the end-result. For example, with proprietary information utility 11, the service could first locate the models that pertain to troubleshooting cellular phones. Then, it would locate a Bayesian belief network engine that operates on these models. Then, it would find the neural network learning services. Finally, it would train a new neural network, by using the loaded Bayesian belief network models as a trainer. The resulting neural network would be translated to the vendor's format and submitted with the request to create the chips and the customer would be billed. From the customer's perspective, the service for blasting the proprietary information into silicon simply executed. Proprietary information broker 26 plays a significant role in extending the apparent functionality of proprietary information utility 11.

An interface exchange system 21 provides standards-based interface descriptions and access over network 10. Interface exchange system 21 allows for a rich selection of devices, services, and products to have uniform access to proprietary information utility 11 and each of the underlying application services. For example, interface exchange system 21 allows users to connect to the proprietary information utility using some or all of the following: a wireless network, cellular phones, internet sites, and applications embedded in appliances, in devices, in vehicle communication and information systems, in intelligent agents, and in memory modules.

An application service registry 25 manages the dynamic registration, access, use, and disposal of application services that operate on top of the proprietary information contained within proprietary information utility 11. Application service registry 25 provides a service catalog, discovery mechanism, and brokering interface that links with proprietary information broker 26 and security system 22 to provide a custom view of available application services, based on entitlement and visibility. Page: 12

One of the values of proprietary information utility 11 is that proprietary information is protected. Many of the services will limit the actual flow of proprietary information to a flow between proprietary information library 27 and the service itself. Since the service is protected by security system 22, the actual proprietary information may never leave proprietary information utility 11. In most cases, the services will make use of the proprietary information to deliver a service, but will not reveal the original proprietary information to the users of the service. For example, a service might indicate what paint to use on a particular surface, without revealing the underlying proprietary information that was used to make that determination (the metallurgical composition of the surface, the chemical composition of the paint, the environmental conditions expected, and the experience of two million previous customers). Proprietary information stored within proprietary information library 27 is within a first category of information that is within private domains established for a user. Or proprietary information stored within proprietary information library 27 is within a second category of information that is available to be licensed for use by multiple users. For example, proprietary information within the second category of proprietary information could include decision support models or models associated with troubleshooting products. The decision support models, for example, can be based on at least one of the following technologies: Bayesian networks, neural networks, case-based systems, model-based systems, rule-based systems, fuzzy systems, decision trees, genetic algorithms, Monte Carlo Markov chains, clustering algorithms, Monte Carlo optimization, simulated annealing, pattern matching, influence diagrams, online analytical processing, collaborative filtering, linear programming, machine learning, and time series.

Services within proprietary information utility can be selected from a broad spectrum of application areas. For example, the services can perform activities related to patents. These activities can, for example, help identify patentable ideas, create patent disclosures, manage pending patents, manage research logs and/or research existing patents.

Other services include, for example, decision support software, software for troubleshooting products, system configuration services, diagnostic services, planning services, selection services, authoring tools that help authors generate appropriate software models, learning services for data-mining and the ongoing evolution of models, business intelligence services, version management services, presentation services, brokering services, stock selection services, investment portfolio troubleshooting services, investment portfolio selection services, services to troubleshoot devices, medical diagnosis services, services that predict failure and behavior, purchasing decision services, consulting services, skills gap analysis services, translation services for translating decision support models from one underlying technology to another, enterprise resource planning services, and customer relationship management services.

Proprietary information utility 11 can also store health records and the application services would then include, for example, services to provide services for supporting healthcare and patients, without revealing private information.

Services to support the creation, maintenance, and deployment of decision support models can support decisions, for example, in the following areas: data-mining, usage reports, business intelligence reports, adaptive learning and refining of models, authoring wizards particular to specific horizontal and vertical industries, and quality benchmarks of models.

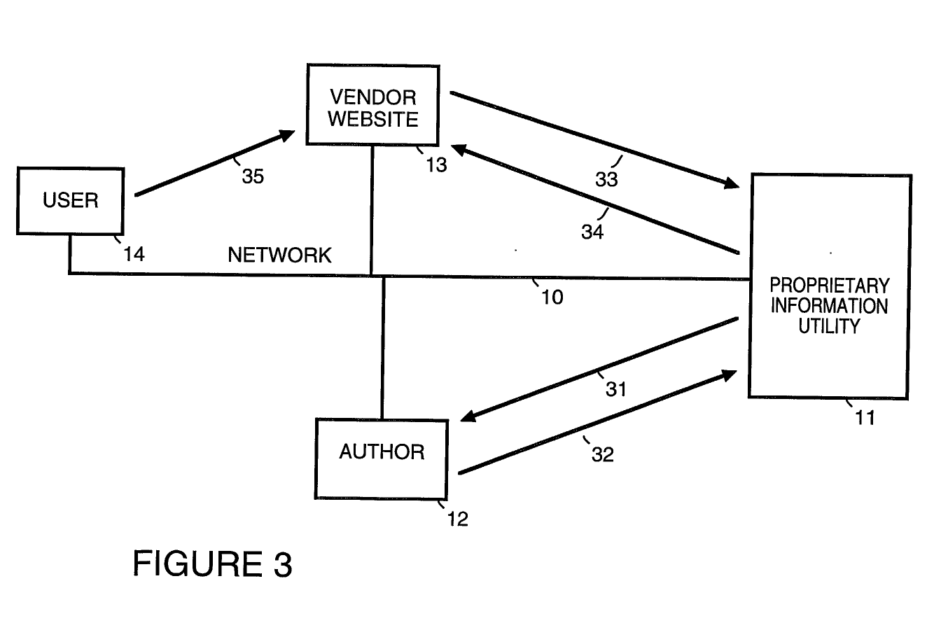

FIG. 3 illustrates revenue flows in accordance with a preferred embodiment of the present invention. The revenue flows may vary in terms of the granularity of the flows, who in the supply chain incorporates proprietary information costs into a more complex business model (i.e., which services appear to be free), and which flows are net-positive or net-negative (where revenue flows in both directions).

Various ways of generating revenue from various transaction types is supported. For example, pay-per-use micro-transactions are supported. In this case, detailed accounting of each internal utility request and the price of underlying proprietary information is used to tally utility costs. These costs may be paid in real time or aggregated over predefined billing periods. For example, an internal utility request is determined by how an observation alters the state of a model in a simulator. For example, the price for using underlying proprietary information may be more expensive for higher quality models than for less detailed or lower quality models.

Revenue also can be generated using vendor-visible service-based pricing. A clear relationship exists between an externally tracked request or event and the price of processing the service request or servicing the event.

Revenue can also be generated using hybrid flows. In this case, revenue flows occur at a higher level, aggregated over fixed periods, but determined by detailed micro-payment accounting and included in a summary.

Revenue can also be generated using subscription-based pricing. Fixed periodic payments create usage entitlements that may be tiered to allow various vendors, authors, or users to manage exposure and financial risk while improving the predictability of revenue flows. For example, a vendor may pay a fixed price for up to 30,000 service-level transactions. Payment beyond the subscription could be pay-per-use, an increased subscription level, or any other supported pricing model. Subscription pricing may also be used to alter entitlement or visibility, while another pricing model is used for usage.

Revenue can also be generated using price bundling. In this case, products or services can be priced to cover unlimited or tier-based subscription levels for an individual product or service.

In FIG. 1, an arrow 33 represents revenue flows from vendors to the operator of proprietary information utility 11 for usage of proprietary information utility 11, storage of proprietary information, entitlement, optional utility services, transaction fees, membership fees, commissions, and so on.

Arrow 34 represents revenue flows to vendor 13 for services posted to proprietary information utility 11, proprietary information royalties for proprietary information utilized by others, and service revenue from their customers, a portion of which is due to the operator of proprietary information utility 11. The services posted to proprietary information utility 11 can be, for example, software that operates within proprietary information utility 11, technology that a vendor shares through proprietary information utility 11, or core engines that manipulate or operate on the proprietary information.

An arrow 31 represents revenue flows to author 12 of proprietary information and services in the form of royalties for usage and subscription rights for proprietary information. An arrow 32 represents revenue flowing from the author to the operator of proprietary information utility 11 for any usage of proprietary information utility 11, storage of proprietary information, entitlement, optional utility services, transaction fees, membership fees, commissions, and so on incurred by author 12.

All customers of the application services within proprietary information utility 11 are billed in accordance with their use of the application services, the entitlement they have to proprietary information, and the utilization of other resources, such as storage. A vendor who provides a value-added service or application may choose any pricing model for their customers and bear the usage cost of the application services.

For example, those who create proprietary information in this environment may choose to grant indirect access to this proprietary information freely or to charge for access. The ASP environment will incorporate this into the revenue flows and will take a commission charge, based upon usage of the underlying proprietary information.

For example, those who publish new services using proprietary information utility 11 will be entitled to pay-per-usage or subscription fees for the service. Proprietary information utility 11 provides publishing services that may be used to control the extent to which proprietary information and associated services are visible, how users are to be charged, and how the publisher will receive compensation.

For example, in one embodiment, proprietary information utility 11 stores decision support models and supplies application e-services for decision-support. In this case the proprietary information consists of, for example, models and services associated with troubleshooters, diagnostics services, planning services, selection services, configuration services, authoring tools that help authors generate appropriate models, learning services for data-mining and the ongoing evolution of models, business intelligence services, version management, presentation services, and so on.

In this embodiment of the present invention proprietary information utility 11 is used to make other products and services “smarter” by leveraging the increasing number of models and the nonlinear growth of synergy between these models. The service is syndicated across a number of industries, including the medical sector, telecommunications, the computer industry, manufacturing, the services industry, and many others.

The present invention provides a novel way to provide living, powerful services to customers, derived from the proprietary information of one or more vendors, while preventing the proprietary information from being copied without an author's permission.

The preferred embodiment of the present invention solves various problems. For example, authoring and control is enhanced because proprietary information utility 11 assists the vendor in creating proprietary information that can be safely stored and managed by the vendor within an ASP environment. This authoring is accomplished through an authoring application service. The vendor retains control of their own proprietary information and can choose the level of visibility and access that anyone may have to this property.

The preferred embodiment of the present invention also facilitates secure availability. Application services may be made available to vendors and customers. These application services typically operate on the proprietary information, without revealing the proprietary information or the proprietary nature of the application services that operate on it.

The preferred embodiment of the present invention also facilitates customization. For example, the application services publish interfaces that become the sole means of access to the underlying proprietary information. The behavior of an application service depends upon the scope of access to proprietary information that the user has. This enables a vendor to provide customized “software” to his or her customers through the same common utility used by everyone.

In addition, the preferred embodiment of the present invention also facilitates transparent, continuous update. Service applications are always up-to-date. Proprietary information utility 11 allows multiple versions of the service application to operate simultaneously. Thus, proprietary information utility 11 can transparently switch users to new versions of the service, without interruption, and can govern this behavior according to the user's risk profile. The risk profile or any other user profile can be used in customizing the user's experience. The customization can be handled by a third party, the utility provider, or may be offered as one of the utility services, depending upon the nature of the profile. The profile can itself be proprietary information.

Also, the preferred embodiment of the present invention facilitates transparent access and incorporation. The functionality provided by the application services may be easily incorporated into any other service, product, or device, provided that the incorporating service, product, or device has access to the network where the service applications are operating. Thus, vendors and users may easily enhance other products and services through the use of these application services. This may be done in a way that makes access to the application service transparent to users of the incorporating service, product, or device.

The preferred embodiment of the present invention also facilitates data separation and control. Vendors and customers may retain complete control of their data and need not incorporate this into the ASP environment.

The preferred embodiment of the present invention also facilitates network effect. The value of the application services will increase as the quantity of underlying proprietary information increases. Thus, the collective value of the application services will increase with usage. Increasing returns to proprietary information utility 11 provider are likely as the market recognizes this increased value and the customer base expands, accelerating the generation of proprietary information and subsequent usage. Further, as more people (authors, vendors, and users) interact with proprietary information utility 11, each of the participants is likely to experience increasing returns. Authors will be able to build upon other published works and will be more attracted to proprietary information utility 11, because of the leverage potential. Users will perceive additional value from access to rapidly evolving services and an ever-increasing base of published proprietary information. Vendors will be attracted to proprietary information utility 11, as they recognize the ability of this utility to attract and retain customers to their portals, services, and products. The marginal value increases non-linearly with each new contribution of proprietary information and each additional author, vendor, or user.

The preferred embodiment of the present invention also facilitates pay-per-use. Users, or intermediaries, only pay for the resources and services that they use, making this a very low risk model.

The preferred embodiment of the present invention also facilitates author compensation. Vendors are compensated for the proprietary information they choose to publish.

The preferred embodiment of the present invention also facilitates operator compensation. The operator of proprietary information utility 11 collects revenue based upon subscription fees, utility usage, and breadth of access.

The functionality of application services depends upon the entitlement of a user to the underlying proprietary information. Thus, generic services are extended to operate within the context of a particular user. This type of customization allows context-dependent services, increased personalization, and tiered levels of service, all from the same application.

Through the use of provided application services, vendors can create a highly differentiated service by creating proprietary information and having it available immediately through proprietary information utility 11 for their customer's use. Thus, vendors can create new services, differentiated by virtue of their proprietary information.

Within the preferred embodiment of the present invention, application services can easily be developed which operate across all proprietary information and aggregate useful information for vendors without compromising any vendor's proprietary position. Application services run in a scaleable, virtual environment, with simple application service interfaces, permitting powerful computation to be deployed to the simplest of devices. Application services run in a resilient, environment in which point failures of specific devices or services do not impact the overall availability or functioning of other devices or services.

When pay-per-use model is used, this allows proprietary information utility 11 to account for a variety of transactions in multiple layers. This allows any user of proprietary information utility 11 to be a net contributor or net user of services and to produce a net revenue or pay a net fee respectively. The proprietary information produced by vendors or service providers is only of value within proprietary information utility 11, as it is meaningless without the associated application services. This affords developers the greatest degree of protection for their proprietary knowledge and ensures that the proprietary information they create is completely protected.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

We claim:

1. A proprietary information utility comprising:
an interface that provides outside entities connection to the proprietary information utility;
a repository that contains proprietary information, wherein the repository is compartmentalized by user identity and entitlement, so that a first category of proprietary information is within private domains available to only a single user and a second category of proprietary information is within domains to which multiple users may be granted use in response to acquiring a license to use particular proprietary information within the second category of proprietary information;
application services;
a security system, that limits access of each user connecting to the proprietary information utility to proprietary information to which each user is entitled, the proprietary information to which each user is entitled being accessed through use of the application services; and,
a billing system for tracking usage by users of the proprietary information utility for billing purposes.

2. A proprietary information utility as in claim 1 wherein the second category of proprietary information includes decision support software.

3. A proprietary information utility as in claim 1 wherein the application services include services to perform at least one of the following activities related to patents:
help identify patentable ideas;
create patent disclosures;
manage pending patents;
manage research logs; and,
research existing patents.

4. A proprietary information utility as in claim 1 wherein the application services include at least one of the services listed below:
decision support software;
software for troubleshooting products;
system configuration services;
diagnostic services;
planning services;
selection services;
authoring tools that help authors generate appropriate software models;
learning services for data-mining and the ongoing evolution of models;
business intelligence services;
version management services;
presentation services;
brokering services;
stock selection services;
investment portfolio troubleshooting services;
investment portfolio selection services;
services to troubleshoot devices;
medical diagnosis services;
services that predict failure and behavior;
purchasing decision services;
consulting services;
skills gap analysis services;
translation services for translating decision support models from one underlying technology to another;
enterprise resource planning services; and,
customer relationship management services.

5. A proprietary information utility as in claim 1 wherein the first category of proprietary information contains health records and the application services include services to provide services for supporting healthcare and patients, without revealing private information.

6. A proprietary information utility as in claim 1 wherein the second category of proprietary information includes proprietary information within at least one of the areas listed below:
decision support models; and,
models associated with troubleshooting products;

7. A proprietary information utility as in claim 1 wherein the second category of proprietary information includes decision support models that are based on at least one of the technologies listed below:
Bayesian networks;
neural networks;
case-based systems;
model-based systems;
rule-based systems;
fuzzy systems;
decision trees;
genetic algorithms;
Monte Carlo Markov chains;
clustering algorithms;
Monte Carlo optimization;
simulated annealing;
pattern matching;
influence diagrams;
online analytical processing;
collaborative filtering;
linear programming;
machine learning; and,
time series.

8. A proprietary information utility as in claim 1 wherein the interfaces allows users to connect to the proprietary information utility using at least one of the following deployment channels:
wireless network;
cellular phones;
internet sites;
applications embedded in appliances;
applications embedded in devices;
applications embedded in vehicle communication and information systems;
applications embedded in intelligent agents; and,
applications embedded in memory modules.

9. A proprietary information utility as in claim 1 wherein the application services include services to support the creation, maintenance, and deployment of decision support models, in at least one of the following areas:
data-mining;
usage reports;
business intelligence reports;
adaptive learning and refining of models;
authoring wizards particular to specific horizontal and vertical industries; and,
quality benchmarks of models.

10. A proprietary information utility as in claim 1 additionally comprising:
an application service registry that manages dynamic registration, access, use, and disposal of the application services.

11. A proprietary information utility as in claim 1 additionally comprising:
a proprietary information broker that maps semi-structured proprietary information requests to a most appropriate proprietary information model and application services that will operate on the most appropriate proprietary information model.

12. A proprietary information utility as in claim 1 wherein the security system provides non-repudiation services in support of billing and reporting

13. A proprietary information utility as in claim 1 wherein the security system provides privacy for all information transmitted outside of the proprietary information utility, allowing proprietary services to make use of proprietary in formation utility without revealing anything about users of the proprietary services and without revealing contents of data moving between services.

14. A proprietary information utility as in claim 1 wherein the billing system provides revenue to be generated using at least one of the following pricing schemes:
pay-per-use micro-transactions;
vendor-visible service-based pricing;
hybrid flows;
subscription-based pricing; and,
price bundling.

15. A proprietary information utility as in claim 1 additionally comprising:
a scaleable computing engine that runs services across many pieces of information.

16. A proprietary information utility as in claim 1 additionally comprising:
a computing engine, the computing engine being used to translate information from an author into a utility-native proprietary information format that can be used by a least a subset of application services within the proprietary information utility.

17. A proprietary information utility as in claim 1 wherein the billing system calculates royalty payments due to authors when proprietary information of the authors is used by the application services within the proprietary information utility.

18. A proprietary information utility as in claim 1 additionally comprising an application service registry that manages dynamic registration, access, use, and disposal of the application services, the application service registry providing a service catalog, a discovery mechanism, and a brokering interface that links with the proprietary information broker and the security system to provide a custom view of available application services; based on entitlement and visibility.

19. A method comprising the following steps:
(a) providing outside entities connection to a proprietary information utility;
(b) storing proprietary information within a repository, wherein the repository is compartmentalized by user identity and entitlement;
(c) limiting access of each user connecting to the proprietary information utility to proprietary information to which each user is entitled, the proprietary information to which each user is entitled being accessed through use of application services operating within the proprietary information utility, wherein multiple users can be granted access to the same proprietary information; and,
(d) tracking usage of users of the proprietary information utility for billing purposes.

20. A method as in claim 19 additionally comprising the following step:
(e) managing dynamic registration, access, use, and disposal of the application services.

21. A method as in claim 19 additionally comprising the following step:
(e) mapping semi-structured proprietary information requests to a most appropriate proprietary information model and application services that will operate on the most appropriate proprietary information model.

22. A method as in claim 19 wherein step (c) includes providing non-repudiation services in support of billing and reporting

23. A method as in claim 19 wherein step (c) includes providing privacy for all information transmitted outside of the proprietary information utility, allowing proprietary services to make use of proprietary information utility without revealing anything about users of the proprietary services and without revealing contents of data moving between services.

24. A method as in claim 19 wherein step (d) includes providing revenue to be generated using at least one of the following pricing schemes:
pay-per-use micro-transactions;
vendor-visible service-based pricing;
hybrid flows;
subscription-based pricing; and,
price bundling.

25. A method as in claim 19 additionally comprising the following step:
(e) translating information from an author into a utility-native proprietary information format that can be used by a least a subset of application services within the proprietary information utility.

26. A method as in claim 26 wherein step (d) includes calculating royalty payments due to authors when proprietary information of the authors is used by the application services within the proprietary information utility.

27. A method as in claim 19 additionally comprising the following step: (e) providing a service catalog, a discovery mechanism to provide a custom view of available application services, based on entitlement and visibility.

28. A method comprising the following steps:
(a) providing outside entities connection to information within a proprietary information utility;
(b) storing proprietary information within a repository, wherein the repository is compartmentalized by user identity and entitlement;
(c) limiting access of each user connecting to the proprietary information utility to proprietary information to which each user is entitled, the proprietary information to which each user is entitled being accessed through use of application services operating within the proprietary information utility;
(d) mapping semi-structured proprietary information requests to a most appropriate proprietary information model and application services that will operate on the most appropriate proprietary information model and,
(e) translating information from an author into a utility-native proprietary information format that can be used by a least a subset of application services within the proprietary information utility.

29. A method comprising the following steps:
(a) providing outside entities connection to information within a proprietary information utility;
(b) storing proprietary information within a repository, wherein the repository is compartmentalized by user identity and entitlement;
(c) limiting access of each user connecting to the proprietary information utility to proprietary information to which each user is entitled, the proprietary information to which each user is entitled being accessed through use of application services operating within the proprietary information utility; and,
(d) providing a service catalog, a discovery mechanism to provide a custom view of available application services, based on entitlement and visibility.
